(19) United States
(12) Patent Application Publication
(10) Pub. No.: US 2003/0029948 A1
(43) Pub. Date: Feb. 13, 2003

(54) Rotary blade fiber chopper

(76) Inventor: Jay Bellasalma, Yorba Linda, CA (US)

Correspondence Address: EMCH, SCHAFFER, SCHAUB & PORCELLO CO, P O BOX 916, ONE SEAGATE SUITE 1980, TOLEDO, OH, 43697

(21) Appl. No.: 09/923,478

(22) Filed: Aug. 7, 2001

(51) Int. Cl. B02C 19/12

(52) U.S. Cl. 241/92

(57) ABSTRACT

This fiber chopper overcomes the disadvantages of the previous cutting rollers for chopping continuous filaments. The apparatus includes a means for feeding continuous fibers through apertures in a fixed head. Rotating blades engage the continuous fiber and chops them into discrete fiber lengths. In another embodiment, a rotating chopping disc with cutting apertures therethrough replaces the fixed head and rotating blades. The cutting apertures have sharp edges for chopping the continuous fibers.

### TECHNICAL FIELD

This invention relates to an apparatus and process for chopping continuous fibers into discrete fiber lengths. More specifically, the apparatus uses rotating blades to chop the discrete fiber lengths.

### BACKGROUND OF THE INVENTION

Fiber choppers typically use cutting rollers to break continuous rovings into individual short fiber lengths. These choppers use a hard rubber back up roll as an anvil which cooperates with the cutting roller carrying one or more transversely extending blades. The back up roll and cutting roller cooperate to chop a discrete fiber length off the continuous roving each time a rotor blade contacts the back up roll.

These cutting rollers work well for producing chopped fibers such as conventional chopped glass fibers.

Continuous filaments include a single filament or a plurality of filaments in a strand, with the filament having continuous length or substantial length, e.g., greater than one foot. A plurality of filaments is a plurality of segments of a single filament in adjacent relationships, such as occurs when a single filament is wrapped around a bobbin tube. Formation of the filaments also normally involves treating the filaments with a size to enhance the properties of the fiberglass in subsequent operations.

Recent advances, however, in after coatings for continuous filaments make the fibers more difficult to chop. The filaments are stiff and tuff and often have rubbery coatings. Conventional cutting rollers often don't cut the stiff fibers. Results often leave the fibers bent or kinked. The typical result is not the clean cut industry desires. Further, the cutting rollers often break blades or do not penetrate the rubbery coatings.

### BRIEF SUMMARY OF THE INVENTION

I have developed a process and apparatus which overcomes the disadvantages of the previous cutting rollers for chopping continuous filaments. My apparatus for chopping continuous fibers into discrete fiber lengths includes at least one fixed head having a first side, a second side with at least one aperture through the fixed head. The apparatus also includes at least one means for feeding at least one continuous fiber through the aperture from the first side of the fixed head. At least one rotating blade on the second side of the fixed head engages the continuous fiber and chops them into discrete fiber lengths.

Preferably, the fixed head has a plurality of apertures therethrough and a plurality of means feeding continuous fibers to the apertures. Preferably, a plurality of rotating blades chop the continuous fibers into chopped fibers of a shorter length. In another embodiment, a rotating chopping disc with cutting apertures therethrough replaces the fixed head and rotating blades. The cutting apertures have sharp edges for chopping the continuous fibers.

### BRIEF DESCRIPTION OF THE DRAWINGS

FIG. 1 is a schematic side view of the apparatus for continuously chopping fiber strands into chopped fibers.

FIG. 2 is a schematic top view of the fixed head of the apparatus showing the aperatures therethrough.

FIG. 3 is a schematic top view showing the rotating blades of the apparatus.

FIG. 4 shows another embodiment of this invention using a rotating chopping disc instead of a fixed head and rotating blades.

FIG. 5 is a top view of the rotating chopping disc.

FIG. 6 shows rotating chopping disc with a gear drive instead of a rotating ball drive.

### DETAILED DESCRIPTION OF THE INVENTION

The apparatus of this invention chops continuous fibers into discrete fiber lengths. The chopper comprises at least one fixed head having a first side, a second side and at least one aperture therethrough. A means feeds at least one continuous fiber through an aperture from the first side of the fixed head. A rotating blade on the second side of the fixed head engages the continuous fiber and chops them into discrete lengths. Preferably, the fixed head has a plurality of apertures therethrough and a plurality of means feed continuous fibers through the apertures. Preferably, the chopper also has a plurality of rotating blades for engaging the continuous fibers. Preferably, the fixed head has a circular shape and the rotating blade rotates in a circular path. Preferably, the apertures in the fixed head are a slot or circular hole. The means for feeding the continuous fiber generally is a pair of nip rollers. In general, the means for feeding the continuous fiber aligns the fiber transverse to the rotating blade.

In another embodiment, the apparatus for chopping continuous fibers into discrete fiber lengths uses a chopper disc instead of a fixed head and blades. This chopper is at least one generally flat planar disc moveably mounted and having a plurality of apertures therethrough bounded by sharp edges. The means for feeding the continuous fibers is the same as the preferred embodiment. The nip rolls feed fibers through the aperatures and the sharp edges chop the continuous fiber into discrete fiber lengths. This chopper includes a means for imparting an orbital motion to the disc relative to the plane of the disc. Generally, the sharp edged apertures are narrow elongated slots.

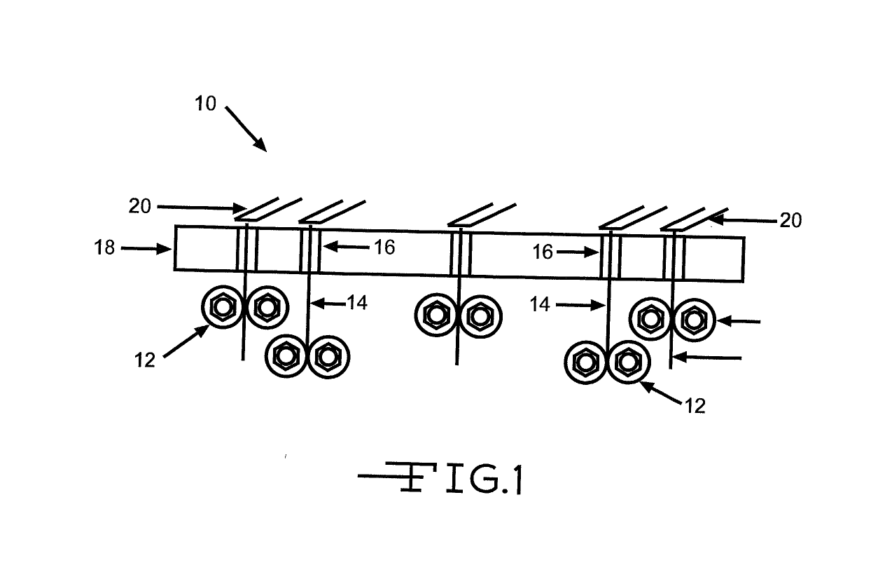

FIG. 1 shows chopper 10 having nip rollers 12 feeding continuous fibers 14 through apertures 16 of fixed head 18. Rotating blades 20 engage fibers 14 and chop them into discrete fiber lengths.

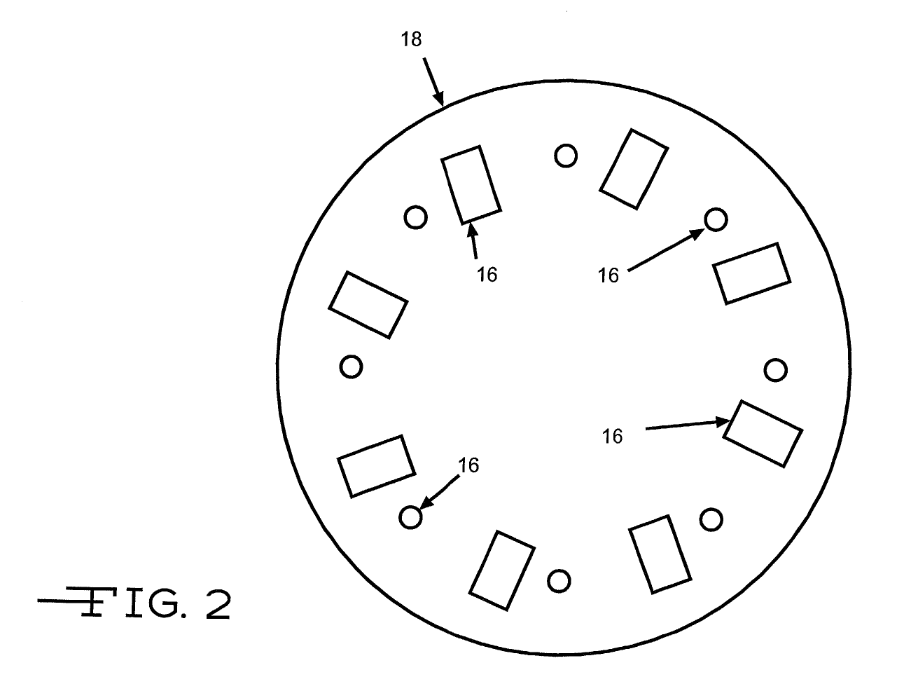

FIG. 2 is a top view of fixed head 18 showing apertures 16.

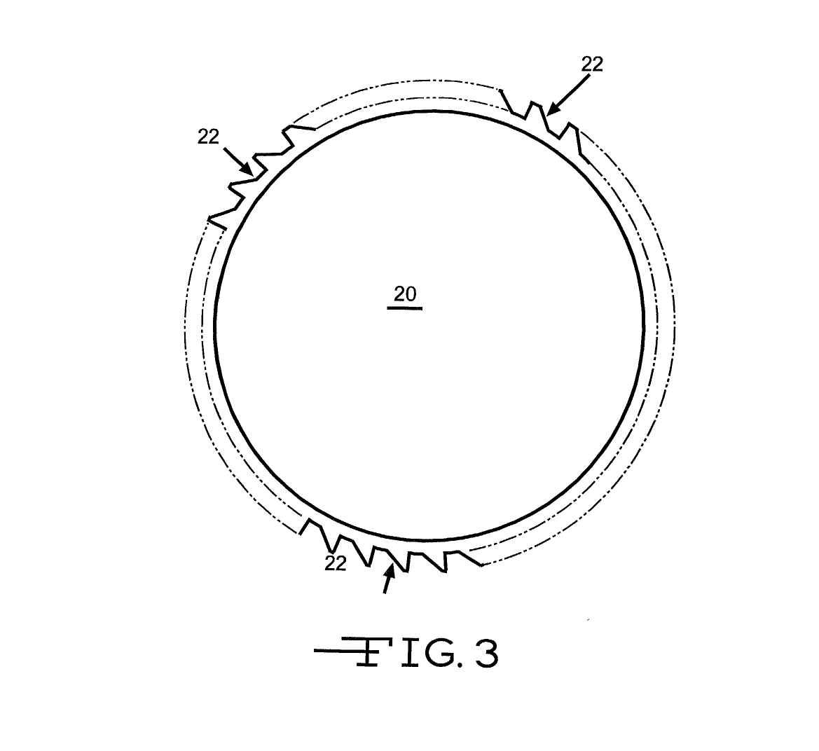

FIG. 3 shows rotating blades 20 having cutting teeth 22.

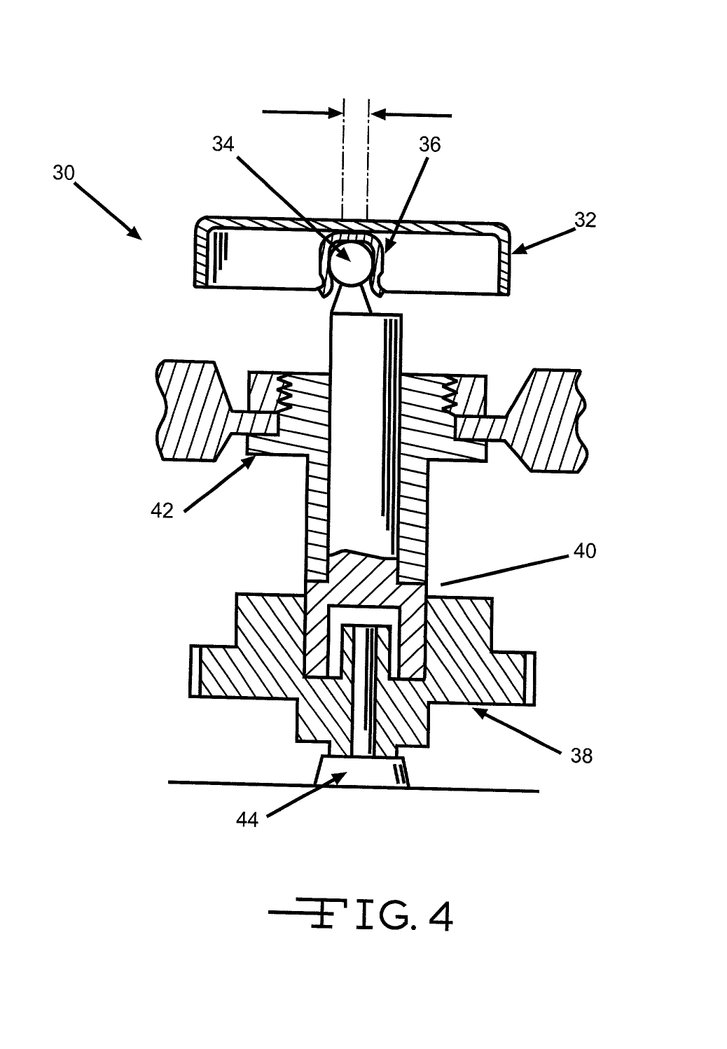

FIG. 4 shows chopper 30 including cutting or chopping disc 32. Ball 34 engages spring 36 which drives disc 32. Drive gear 38 rotates drive shaft 40. Shaft 40 supports ball 34 and rotates disc 32 through spring 36. Bearings 42 and 44 allow shaft 40 to rotate.

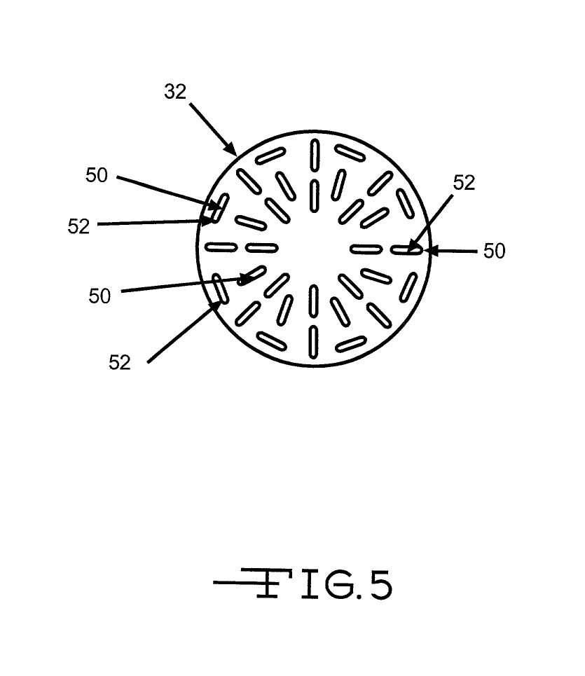

FIG. 5 is a top view of disc 32 showing apertures 50 in greater detail. Apertures 50 have sharp edges 52.

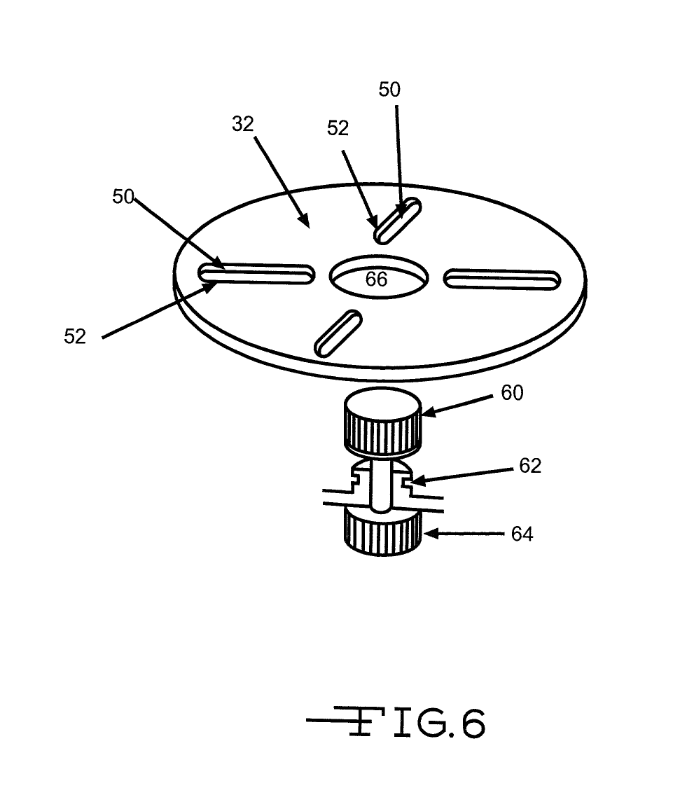

FIG. 6 shows gear 60 driving disc 32. Drive shaft 62 supports gear 60 and drive gear 64 rotates shaft 62. Gear 60 engages aperture 66 in disc 32 to provide rotation thereto. FIG. 6 also shows slots 50 and cutting edges 52 in greater detail.

This unique chopper was designed for processing reinforcements having a specific coating thereon. Preferably, the mixture is an epoxy/polystyrene mixture developed for coating glass fiber reinforcements for thermoset resins such as polyesters. First, the glass is coated and dried. After drying, the roving then is wrapped around chilled mandrels and chopped into an appropriate length.

These after coated reinforcements are described in U.S. patent application Ser. No. 09/829,095, filed Apr. 9, 2001 and herein incorporated by reference.

In addition to these embodiments, persons skilled in the art can see that numerous modifications and changes may be made to the above invention without departing from the intended spirit and scope thereof.

I claim:

1. An apparatus for chopping continuous fibers into discrete fiber lengths comprising:
at least one fixed head having a first side, a second side and at least one aperture therethrough;
at least one means for feeding at least one continuous fiber through the at least one aperture from the first side; and
at least one rotating blade on the second side of the at least one fixed head engaging the at least one continuous fiber.

2. An apparatus for chopping continuous fibers into discrete fiber lengths comprising:
a fixed head having a first side, a second side and a plurality of apertures therethrough;
a plurality of means for feeding continuous fibers through the apertures from the first side; and
a plurality of rotating blades on the second side of the fixed head engaging the continuous fibers.

3. An apparatus according to claim 1 wherein the fixed head has a circular shape and the rotating blade rotates in a circular path.

4. An apparatus according to claim 1 wherein the aperture in the fixed head is a slot or circular hole.

5. An apparatus according to claim 1 wherein the means for feeding the continuous fiber is a pair of nip rollers.

6. An apparatus according to claim 1 wherein the means for feeding the continuous fiber aligns the fiber transverse to the rotating blade.

7. A process for chopping continuous fibers into discrete fiber lengths comprising the steps of:
providing at least one fixed head having a first side, a second side and at least one aperture therethrough;
at least one continuous fiber through the at least one aperture from the first side; and
rotating at least one blade on the second side of the at least one fixed head wherein the rotating blade engages the at least one continuous fiber and chops the continuous fiber into discrete fiber lengths.

8. An apparatus for chopping continuous fibers into discrete fiber lengths comprising:
at least one generally flat planar disc moveably mounted and having a plurality of apertures therethrough bounded by sharp edges; and
at least one means for feeding at least one continuous fiber through the aperatures wherein the sharp edges chop the continuous fiber into discrete fiber lengths.

9. An apparatus according to claim 8 including means for imparting an orbital motion to the disc relative to the plane of the disc.

10. An apparatus according to claim 8 wherein the apertures are narrow elongated slots.
